(19) United States
(12) Patent Application Publication
(10) Pub. No.: US 2026/0252422 A1
(43) Pub. Date: Aug. 27, 2026

(54) DATA ELEMENT ANALYSIS AND APPROVAL ENGINE

(71) Applicant: Capital One Services, LLC, McLean, VA (US)

(72) Inventors: Karandeep BHATIA, Buffalo Grove, IL (US); Vigneshwaran KENNADY, Frisco, TX (US); Pushkaraj MOHILE, Chesterbrook, PA (US); Sreekanth NELAKURTHI, Middletown, DE (US); Neeru GOYAL, Herndon, VA (US); Kien DO, Derwood, MD (US)

(21) Appl. No.: 19/065,371

(22) Filed: Feb. 27, 2025

(51) Int. Cl. G06F 9/54

(52) U.S. Cl. CPC G06F 9/546

(57) ABSTRACT

In some implementations, a system may receive, via a data element portal, a data element for analysis. The system may generate, based on the first set of parameters, an enhanced data element. The system may analyze the enhanced data element to identify one or more approval processes. The system may obtain information identifying a set of outputs responsive to the request for the approval associated with the data element. The system may transmit the information identifying the set of outputs to fulfill the request for the approval associated with the data element.

### BACKGROUND

A data processing system may receive a data element and perform one or more processing actions on the data element. To alter the one or more processing actions, developers may alter one or more parameters of the data processing system. When one or more parameters of the data processing system are updated, a user interface, provided via a client device to a user, may be updated accordingly. Such data processing systems may be used in the context of manufacturing control, supply chain control, or application submission and approval, among other contexts.

### SUMMARY

Some implementations described herein relate to a system for data element analysis and approval. The system may include one or more memories and one or more processors communicatively coupled to the one or more memories. The one or more processors may be configured to receive, via a data element portal, a data element for analysis, wherein the data element includes a first set of parameters associated with the data element and a request for an approval associated with the data element. The one or more processors may be configured to generate, using the data element and based on the first set of parameters, an enhanced data element, wherein the enhanced data element is associated with the first set of parameters and a second set of parameters. The one or more processors may be configured to identify, for the enhanced data element, a set of approval processes. The one or more processors may be configured to perform a set of calls on the set of approval processes to generate, for the enhanced data element, a set of outputs responsive to the request for the approval associated with the data element. The one or more processors may be configured to receive, as a response to the set of calls, information identifying the set of outputs responsive to the request for the approval associated with the data element. The one or more processors may be configured to transmit the information identifying the set of outputs to fulfill the request for the approval associated with the data element.

Some implementations described herein relate to a method for data element analysis and approval. The method may include receiving, by a system and via a data element portal, a data element for analysis, wherein the data element includes a first set of parameters associated with the data element and a request for an approval associated with the data element; generating, by the system and based on the first set of parameters, an enhanced data element, wherein the enhanced data element is associated with the first set of parameters and a second set of parameters; and analyzing, by the system, the enhanced data element to identify one or more approval processes. The method may include transmitting, by the system, one or more application programming interface (API) calls on one or more modules to trigger the one or more approval processes. The method may include receiving, by the system and as a response to the one or more API calls, information identifying a set of outputs responsive to the request for the approval associated with the data element, transmitting, by the system, the information identifying the set of outputs to fulfill the request for the approval associated with the data element.

Some implementations described herein relate to a non-transitory computer-readable medium that stores a set of instructions. The set of instructions, when executed by one or more processors of a system, may cause the system to receive, via a data element portal, a data element for analysis, wherein the data element includes a first set of parameters associated with the data element and a request for an approval associated with the data element. The set of instructions, when executed by one or more processors of the system, may cause the system to generate, using the data element and based on the first set of parameters, an enhanced data element, wherein the enhanced data element is associated with the first set of parameters and a second set of parameters. The set of instructions, when executed by one or more processors of a system, may cause the system to identify, for the enhanced data element, a set of approval processes. The set of instructions, when executed by one or more processors of a system, may cause the system to perform a set of calls on the set of approval processes to generate, for the enhanced data element, a set of outputs responsive to the request for the approval associated with the data element. The set of instructions, when executed by one or more processors of a system, may cause the system to receive, as a response to the set of calls, information identifying the set of outputs responsive to the request for the approval associated with the data element. The set of instructions, when executed by one or more processors of a system, may cause the system to transmit the information identifying the set of outputs to fulfill the request for the approval associated with the data element.

Some aspects described herein relate to a system for request analysis and approval. The computer system may include a processor set, one or more computer-readable storage media, and program instructions stored on the one or more computer-readable storage media to cause the processor set to perform operations. The operations may include receiving, via an interface, an initial request. The operations may include generating, using the initial request and based on the first set of parameters, an enhanced request. The enhanced request is associated with the first set of parameters and a second set of parameters. The operations may include identifying, for the enhanced request, a set of processes based on one or more parameters of the enhanced request. The operations may include identifying, for the set of processes, a set of systems with which to communicate to generate a set of outputs. The operations may include performing a set of calls on the set of systems to generate, for the enhanced request and using the set of processes, the set of outputs responsive to the initial request. The operations may include receiving, as a response to the set of calls, information identifying the set of outputs responsive to the initial request. The operations may include transmitting the information identifying the set of outputs to fulfill the initial request.

Some aspects described herein relate to a non-transitory computer-readable medium that stores a set of instructions by a system. The set of instructions, when executed by one or more processors of the system, may cause the system to receive a submission for analysis. The set of instructions, when executed by one or more processors of the system, may cause the system to generate, using the submission and based on the first set of parameters, an enhanced submission. The set of instructions, when executed by one or more processors of the system, may cause the system to identify, for the enhanced submission, a set of approval processes. The set of instructions, when executed by one or more processors of the system, may cause the system to perform a set of calls on the set of approval processes to generate, for the enhanced submission, a set of outputs responsive to the request for the approval associated with the submission. The set of instructions, when executed by one or more processors of the system, may cause the system to receive, as a response to the set of calls, information identifying the set of outputs responsive to the request for the approval associated with the submission. The set of instructions, when executed by one or more processors of the system, may cause the system to transmit the information identifying the set of outputs to fulfill the request for the approval associated with the submission.

### BRIEF DESCRIPTION OF THE DRAWINGS

FIGS. 1A-1E are diagrams of an example implementation associated with data element analysis, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with data element analysis and approval, in accordance with some embodiments of the present disclosure.

FIG. 4 is a flowchart of an example process associated with data element analysis, in accordance with some embodiments of the present disclosure.

### DETAILED DESCRIPTION

The following detailed description of example implementations refers to the accompanying drawings. The same reference numbers in different drawings may identify the same or similar elements.

A data processing system may receive a data element and perform one or more processing steps on the data element. The data element may include a submission or a request in a data form, such as a set of parameters or fields that are set to convey information of a submission or a request. For example, a data element may include a Hypertext Transfer Protocol (HTTP) request. Based on performing the one or more processing steps, the data processing system may perform one or more output steps. For example, the data processing system may store the data element (or a version thereof) or output a response to the data element, such as an indication that the data element is accepted or rejected. The data element being accepted or rejected may include an acceptance or rejection of underlying information of the data element, such as an acceptance or rejection of a submission or request that is conveyed via the data element. When the data processing system is updated, one or more dependent systems may be updated in parallel to avoid functionality losses. For example, when there is a change to the one or more processing steps, the data processing system may be updated along with one or more front-end systems that client devices use to submit data elements. Additionally, or alternatively, many data processing systems may be deployed to perform many different workflows of data processing steps. This may result in an excessive utilization of computing resources, such as processing resources, to provide the many different workflows, which may have overlapping or similar steps. Similarly, each client device may store information relating to each different data processing system, resulting in an excessive use of data storage resources.

Some implementations described herein may provide a data analysis system that orchestrates one or more processing workflows for data elements, which may include submissions or requests. For example, a data analysis system may receive data elements as an input and may select one or more workflows for processing the data elements and generating outputs. In this case, when a workflow is altered, the data analysis system can be altered accordingly without changes being made to client devices. In other words, the data analysis system may provide an interface between the client devices and the back-end systems that perform processing steps on the data elements. In this way, an amount of processing resources used to perform data processing on data elements may be reduced relative to having separate data processing systems for each workflow, and an amount of data storage may be reduced relative to having separate systems for each data element.

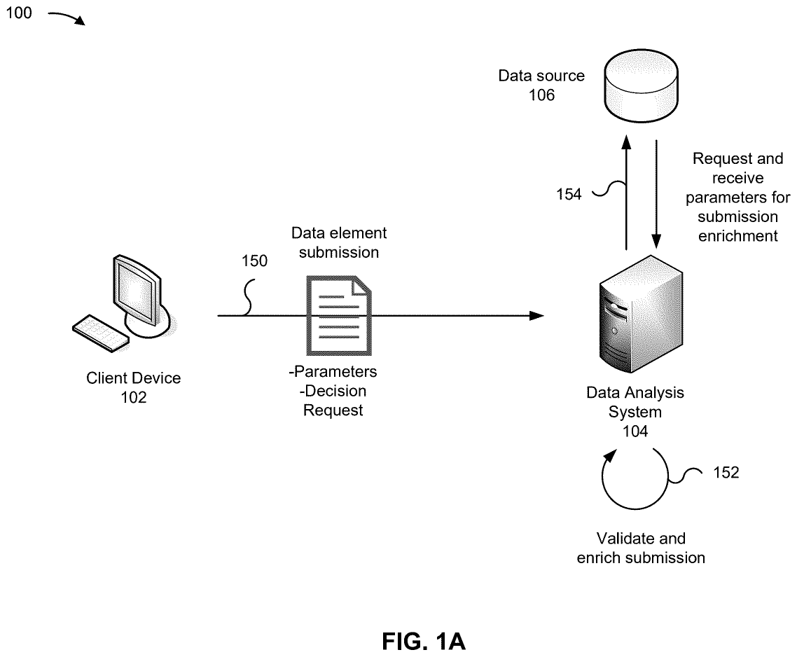

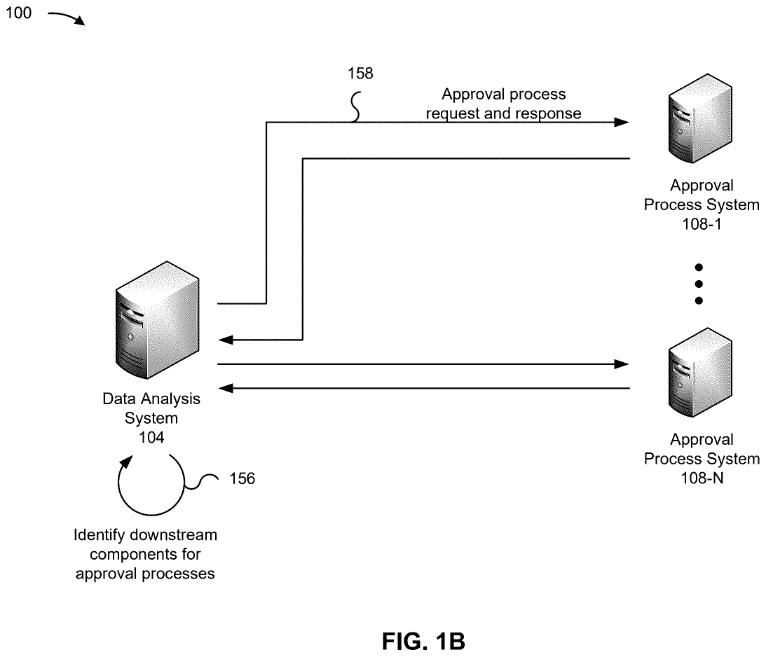

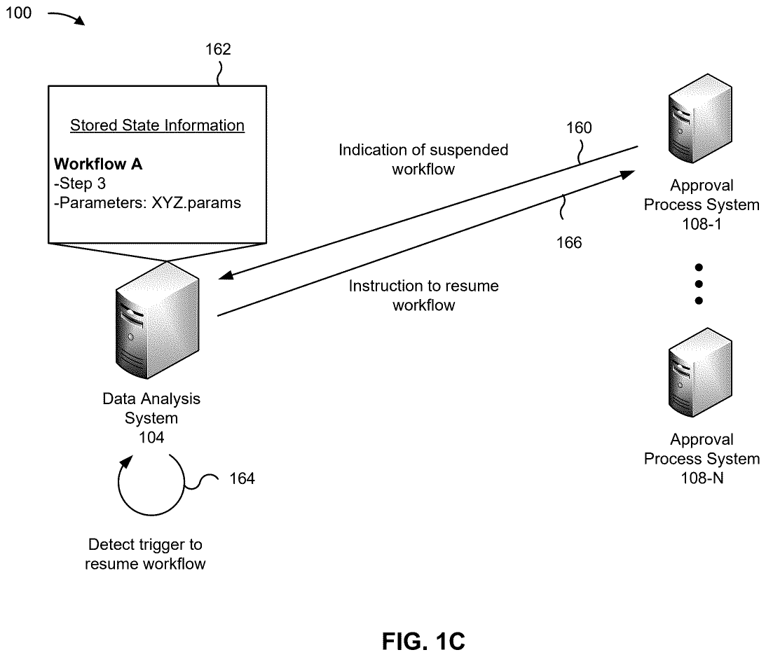

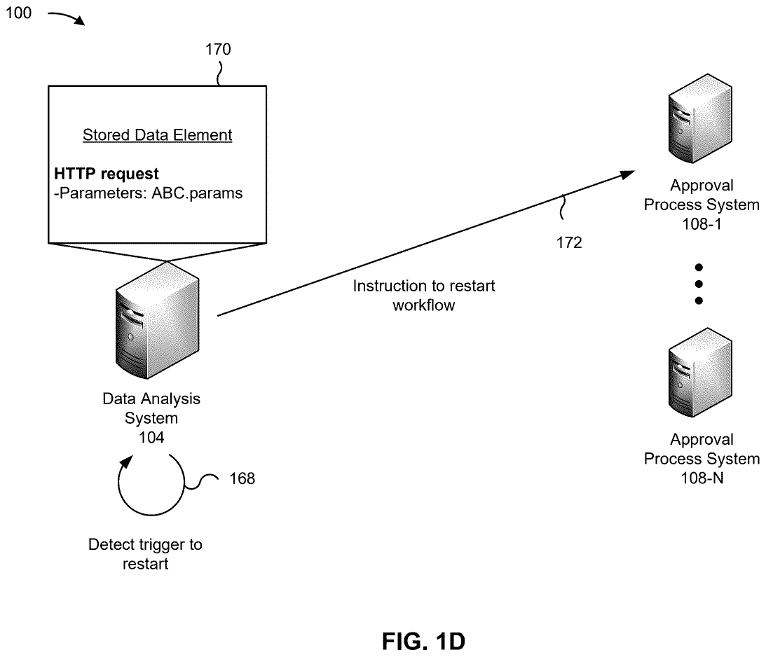

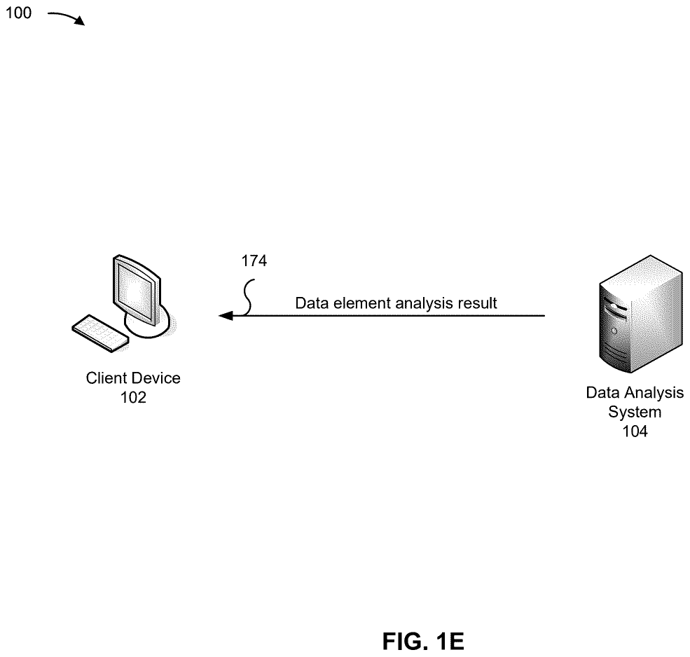

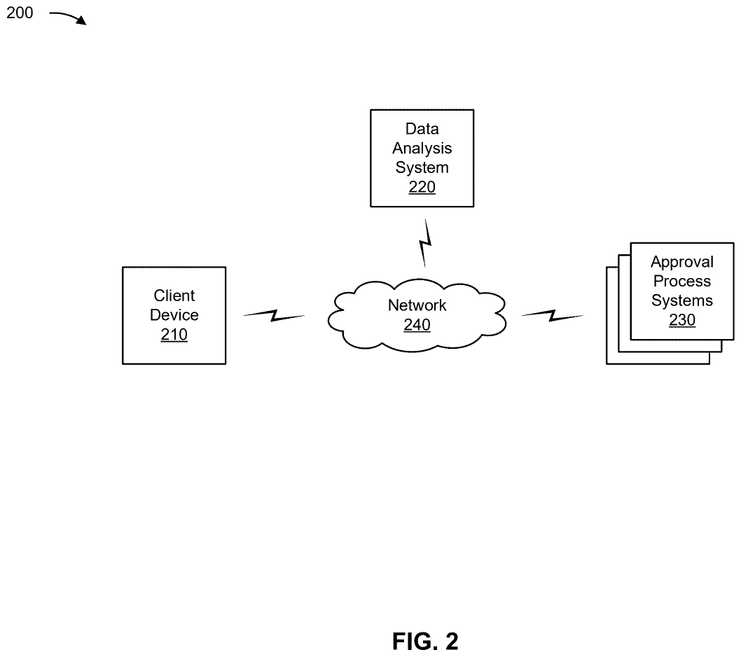

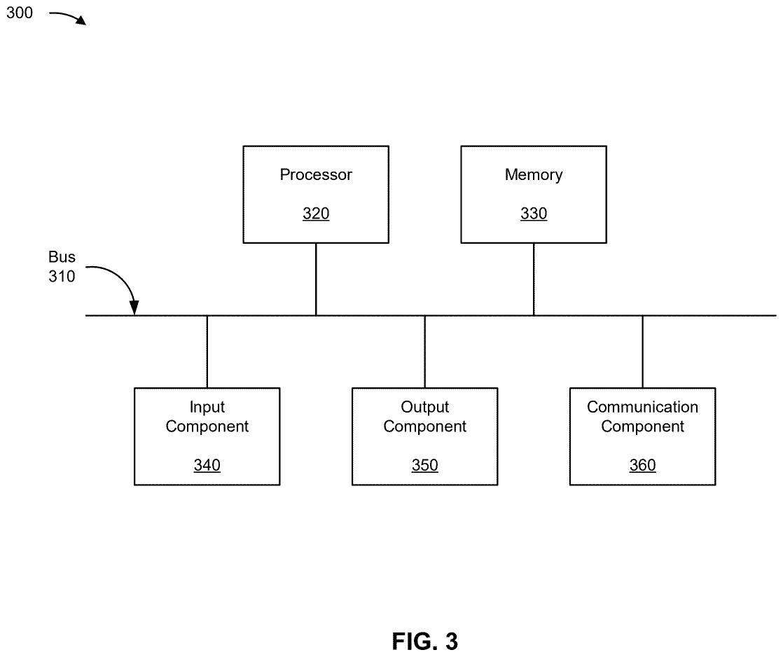

FIGS. 1A-1E are diagrams of an example implementation 100 associated with data element analysis. As shown in FIGS. 1A-1E, example implementation 100 includes a client device 102 and a data analysis system 104. These devices are described in more detail below in connection with FIG. 2 and FIG. 3.

As further shown in FIG. 1A, and by reference 150, the data analysis system 104 may receive a data submission. For example, the data analysis system 104 may receive a data element with a set of parameters. The set of parameters may include one or more parameters that form a submission or a request and that, when processed, may be analyzed to determine whether to approve or reject the submission or request. For example, the data analysis system 104 may receive an HTTP request that includes one or more parameters. Additionally, or alternatively, the data analysis system 104 may receiver another protocol request. Additionally, or alternatively, the data analysis system 104 may receive a decision request. In some implementations, a first data element message may convey the data element and a second data element message may convey the decision request. In some implementations, the data analysis system 104 may receive a data element submission associated with a particular context. For example, the data analysis system 104 may receive a data element submission relating to a credit card application, an insurance claim, an educational admission, a discount eligibility determination, a hiring determination, a travel booking or authorization, a service request, a compliance determination, or a supply chain control determination.

In some implementations, the data analysis system 104 may receive a data element submission that includes a first set of parameters. For example, the data analysis system 104 may receive a data element submission that includes information identifying a submitter of the data element submission, a type of the data element submission, a request associated with the data element submission, or another parameter. In other words, in the context of a credit card application, the data analysis system 104 may receive information identifying a submitter of the credit card application, an income level of the submitter, or an employer of the submitter, among other examples. Similarly, in the context of a compliance determination, the data analysis system 104 may receive a data element submission that includes information identifying a compliance level for which a determination is requested, a set of protocols implemented to satisfy the compliance level, or a credential that the data analysis system 104 (or a system associated therewith) can use to access one or more target systems for evaluating the set of protocols with respect to the compliance level. Similarly, in the context of a supply chain control submission, the data analysis system 104 may receive a data element submission identifying a set of parameters used by one or more manufacturing devices, such as settings relating to usage of raw materials, processing or manufacturing speed settings, or inventory data.

In some implementations, the data analysis system 104 may receive the data submission via an application programming interface (API). For example, the data analysis system 104 may provide a backward compatible API for submitting data submission requests, and may translate one or more API calls associated with the data submission requests into one or more formats compatible with an approval workflow configured for the data submission request. In some implementations, the data analysis system 104 may receive configuration information or a lambda state associated with the data submission. For example, the data analysis system 104 may determine a type of request associated with the data submission and may receive information indicating a configuration for processing the type of request, thereby enabling reuse of an approval workflow for the data submission. In this case, the data analysis system 104 may communicate with a configuration system by transmitting a request message to the configuration system with a subset of a first set of parameters (included in the data submission) and may receive a response message from the configuration system with at least a subset of a second set of parameters (that are to be used to enrich the data submission and generate an enriched data submission).

As further shown in FIG. 1A, and by reference number 152, the data analysis system 104 may validate and enrich the data submission. For example, the data analysis system 104 may obtain a second set of parameters to include in the data submission based on information included in the data submission (e.g., a first set of parameters). For example, in the context of a credit card application, the data analysis system 104 may use identification information to obtain a credit score, a credit history, a set of public records, a verification of an income level, or a verification of an employment history. As shown in FIG. 1A, and by reference number 154, the data analysis system 104 may request and receive a set of parameters, from a data source 106, for enriching the data submission. For example, the data analysis system 104 may request information identifying a set of employment dates from an employment verification system or an income level from a financial data system. Similarly, in the context of a compliance determination, the data analysis system 104 may identify a set of requirements associated with a particular compliance level. For example, the data analysis system 104 may transmit information identifying the compliance level to a compliance data structure and may receive information identifying a set of requirements for the identified compliance level. Additionally, or alternatively, in the context of a supply chain control determination, the data analysis system 104 may access a vendor data structure identifying possible vendors for raw materials, a shipment data structure identifying shipping times for different raw materials, or a configuration data structure identifying possible configurations for a manufacturing device to adjust manufacturing speed, among other examples.

In some implementations, the data analysis system 104 may access a data store or configuration catalog to receive information for enriching the data submission. For example, the data analysis system 104 may access a key-value data store, and use one or more first parameters of the first set of parameters to identify one or more second parameters of the second set of parameters that are linked to the one or more first parameters.

As shown in FIG. 1B, and by reference number 156, the data analysis system 104 may identify a set of downstream components for one or more approval processes. For example, the data analysis system 104 may identify a set of approval process systems 108 for executing a set of approval workflows relating to the data submission. An approval workflow may include one or more processes configured for analyzing the data submission as an input and generating an output. For example, an approval workflow may include a binary approval process (e.g., for indicating an approval or rejection), a numerical approval process (e.g., for indicating a numerical value), or a categorical approval process (e.g., for assigning a data submission to a category), among other examples. In some implementations, an approval workflow may be associated with execution of a machine learning or artificial intelligence model, such as a decision tree based model, a cluster assignment based model, or another type of model.

In some implementations, the data analysis system 104 may identify the set of approval process systems 108 based on a type of data submission. For example, the data analysis system 104 may store information identifying a mapping of data submission types to approval process systems 108. Additionally, or alternatively, the data analysis system 104 may store information identifying a mapping of one or more parameters of data submissions to approval process systems 108. For example, the data analysis system 104 may identify a first set of approval process systems 108 for a data submission relating to a credit card application from a user in a first geographic location and a second set of approval process systems 108 for a data submission elating to a credit card application from a user in a second geographic location. Additionally, or alternatively, the data analysis system 104 may identify a first set of approval process systems 108 for a first type of compliance determination and a second set of approval process systems 108 for a second type of compliance determination.

In some implementations, the data analysis system 104 may identify a second approval process system 108 based on a result of requesting completion of a workflow associated with a first approval process system 108. For example, in the context of a credit card application, based on an approval being determined for the credit card application using a first approval process system 108, the data analysis system 104 may identify a second approval process system 108 for determining a reward offer to associate with the approval and a third approval process system 108 for determining an interest rate associated with the approval. Similarly in the context of a compliance determination, the data analysis system 104 may identify a first approval process system 108 for determining a first level of compliance and a second approval process system 108 for determining a second level of compliance based on satisfaction of the first level of compliance.

In some implementations, the data analysis system 104 may identify an approval process system 108 and an associated approval process based on a set of candidate approval processes. For example, the data analysis system 104 may access a data structure storing information identifying a set of candidate approval processes, and the data analysis system 104 may select one or more approval processes from the set of candidate approval processes.

As further shown in FIG. 1B, and by reference number 158, the data analysis system 104 may transmit an approval process request and receive an approval process response. For example, the data analysis system 104 may transmit a request that an approval process system 108 complete an approval process workflow and provide a response. In this case, the data analysis system 104 may receive results of the approval process system 108 completing the approval process workflow, such as receiving an approval of a data submission, a rejection of a data submission, or another type of output as described in more detail herein. In some implementations, the data analysis system 104 may obtain a result of an approval process using an application programming interface (API). For example, the data analysis system 104 may provide a first API for receiving the data submission and may use a second API to request completion of an approval process workflow on the enriched data submission.

In some implementations, the data analysis system 104 may dynamically control a workflow of an approval workflow associated with an approval process system 108. For example, the data analysis system 104 may exchange one or more messages with the approval process system 108 to provide resolutions at one or more decision blocks of a workflow being executed by the approval process system 108. In this case, the data analysis system 104 may communicate with the client device 102 to receive follow-up user input. In some implementations, the data analysis system 104 may use a step function to orchestrate an approval process.

In some implementations, the data analysis system 104 may suspend (or may detect suspension of) a workflow. For example, as shown in FIG. 1C, the data analysis system 104 may receive an indication of a suspended workflow from the approval process system 108-1. In some implementations, the data analysis system 104 may suspend a workflow based on a request message. For example, when completion of a step of a workflow requires input of information that is unavailable to the approval process system 108-1, the data analysis system 104 may receive (and provide, to a user device of a user) a request for the input of information and may suspend the workflow until the input of information is provided.

In some implementations, the data analysis system 104 may detect a stuck state or failure associated with a workflow. For example, the data analysis system 104 may communicate with the approval process system 108 to determine a state of one or more procedures of an approval workflow. In this case, based on determining that the state matches a configured error state or based on the state not updating within a configured period of time, the data analysis system 104 may detect an error or stuck state. In this case, the data analysis system 104 may re-instantiate an approval workflow from a stored state of the approval workflow.

In some implementations, the data analysis system 104 may receive information identifying a state associated with the suspended workflow. For example, the data analysis system 104 may receive state information 162 and may store the state information 162 in a data structure.

As shown by reference numbers 164 and 166, the data analysis system 104 may detect a trigger to resume a workflow and may transmit a message to cause the workflow to be resumed. For example, the data analysis system 104 may receive an indication that a request has been fulfilled. In this case, when a request (e.g., of additional information for completing a workflow is fulfilled), the data analysis system 104 may resume the workflow from a stored state using the stored state information 162. For example, the data analysis system 104 may provide the stored state information 162 to the approval process system 108-1 to resume the workflow from a stored state. In some implementations, the data analysis system 104 may restart an approval workflow from a last-known working state, thereby resuming the approval workflow without restarting the approval workflow from an initial state. In some implementations, the data analysis system 104 may reuse an approval workflow across different requests. For example, the data analysis system 104 may store different configurations for an approval workflow and may provide, with a data submission, a configuration selected based on the data submission. In this case, the configuration may cause the approval workflow to process the data submission in accordance with a type of request with which the data submission is associated. In this way, by storing the state information, the data analysis system 104 obviates a need to restart a workflow from an initial step, thereby reducing a utilization of processing resources. In some implementations, the data analysis system 104 may store state information 162 for resuming a workflow for a particular period of time. For example, the data analysis system 104 may store state information 162 for a day, a week, a month, a year, or another period of time.

In some implementations, the data analysis system 104 may a workflow. For example, as shown in FIG. 1D, the data analysis system 104 may determine to restart a workflow based on detecting a trigger. In some implementations, the data analysis system 104 may stop a workflow based on detecting a failure. For example, the data analysis system 104 may determine that an approval process system 108-1 is offline, such as for updating or reconfiguration or as a result of an outage. In this case, the data analysis system 104 may stop a workflow that is to be executed on the approval process system 108-1. When the data analysis system 104 detects that the approval process system 108-1 has returned online, the data analysis system 104 may restart a workflow. For example, rather than having a user resubmit the data element 170, the data analysis system 104 may store the data element 170 (e.g., an HTTP request) until the approval process system 108-1 is available and may automatically restart a workflow associated with the approval process system 108-1 to process the data element 170. In this case, the data analysis system 104 may transmit an instruction 172 to the approval process system 108-1 to restart the workflow.

As shown in FIG. 1E, and by reference number 174, the data analysis system 104 may transmit a data element analysis result. For example, the data analysis system 104 may output, to the client device 102, a data submission result. In some implementations, the data analysis system 104 may provide a plurality of outputs to the client device 102 in connection with the data element analysis result. For example, the data analysis system 104 may output a result of a first approval process, a result of a second approval process, or a result of an nth approval process, among other examples. As a particular example, in the context of a credit card application, the data analysis system 104 may provide a first output indicating whether a request for approval is granted, a second output indicating an offer associated with the approval, and a third output indicating one or more terms or conditions of the approval (e.g., an amount of time to accept the offer, an interest rate associated with the offer, or another condition), among other examples.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

FIG. 2 is a diagram of an example environment 200 in which systems and/or methods described herein may be implemented. As shown in FIG. 2, environment 200 may include a client device 210, a data analysis system 220, one or more approval process systems 230, and a network 240. Devices of environment 200 may interconnect via wired connections, wireless connections, or a combination of wired and wireless connections.

The client device 210 may include one or more devices capable of receiving, generating, storing, processing, and/or providing information associated with a request for analysis and approval of a data element (e.g., which may convey, in a data form, a submission or a request or a set of parameters thereof), as described elsewhere herein. The client device 210 may include a communication device and/or a computing device. For example, the client device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data analysis system 220 may include one or more devices capable of receiving, generating, storing, processing, providing, and/or routing information associated with analyzing a data element (e.g., which may convey, in a data form, a submission or a request or a set of parameters thereof), as described elsewhere herein. The data analysis system 220 may include a communication device and/or a computing device. For example, the data analysis system 220 may include a server, such as an application server, a client server, a web server, a database server, a host server, a proxy server, a virtual server (e.g., executing on computing hardware), or a server in a cloud computing system. In some implementations, the data analysis system 220 may include computing hardware used in a cloud computing environment, such as one or more serverless components (e.g., one or more serverless functions), among other examples.

The approval process system 230 may include one or more devices capable of receiving, generating, storing, processing, providing, and/or routing information associated with executing one or more workflows, as described elsewhere herein. The approval process system 230 may include a communication device and/or a computing device. For example, the approval process system 230 may include a server, such as an application server, a client server, a web server, a database server, a host server, a proxy server, a virtual server (e.g., executing on computing hardware), or a server in a cloud computing system. In some implementations, the approval process system 230 may include computing hardware used in a cloud computing environment, such as one or more serverless components (e.g., one or more serverless functions), among other examples.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with data element analysis and approval. The device 300 may correspond to client device 210, data analysis system 220, and/or approval process system 230. In some implementations, client device 210, data analysis system 220, and/or approval process system 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

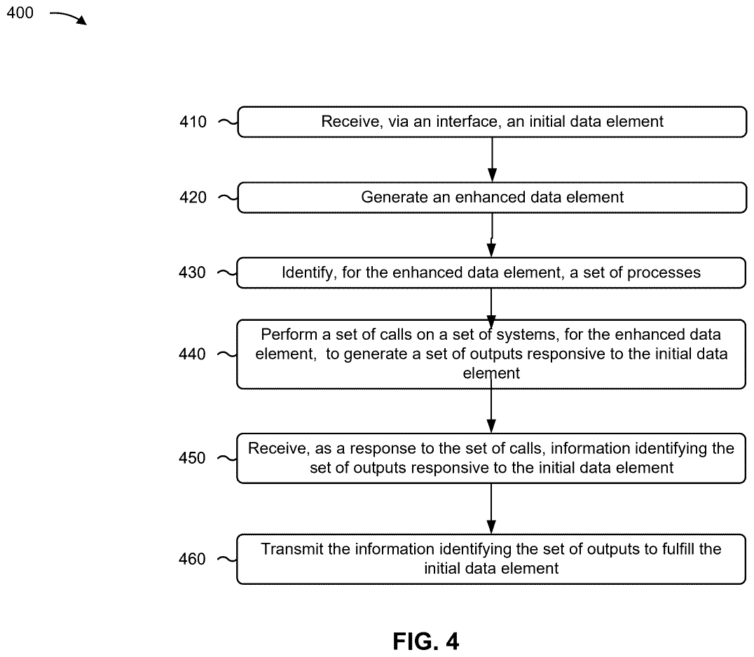

FIG. 4 is a flowchart of an example process 400 associated with data element analysis. In some implementations, one or more process blocks of FIG. 4 may be performed by the data analysis system 220. In some implementations, one or more process blocks of FIG. 4 may be performed by another device or a group of devices separate from or including the data analysis system 220, such as the client device 210 and/or the approval process systems 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving, via an interface, an initial data element (block 410). For example, the data analysis system 220 (e.g., using processor 320, memory 330, input component 340, and/or communication component 360) may receive, via a data element portal, a data element or request for analysis, as described above in connection with reference number 150 of FIG. 1A. As an example, the data analysis system 220 may receive a credit card application via a credit card application portal. In some implementations, the data element includes a first set of parameters associated with the data element and a request for an approval associated with the data element.

As further shown in FIG. 4, process 400 may include generating an enhanced data element (block 420). For example, the data analysis system 220 (e.g., using processor 320 and/or memory 330) may generate, using the data element and based on the first set of parameters, an enhanced data element or enhanced request, as described above in connection with reference number 154 of FIG. 1A. As an example, the data analysis system 220 may request, receive, and incorporate into the data element additional user data, contextual data, or other data that can be used in evaluating the credit card application. In some implementations, the enhanced data element is associated with the first set of parameters and a second set of parameters.

As further shown in FIG. 4, process 400 may include identifying, for the enhanced data element, a set of processes (block 430). For example, the data analysis system 220 (e.g., using processor 320 and/or memory 330) may identify, for the enhanced data element or request, a set of approval processes, as described above in connection with reference number 156 of FIG. 1B. As an example, the data analysis system 220 may identify one or more processes or workflows that are to be used to evaluate the enhanced data element to determine whether to generate an approval and/or any other output information.

As further shown in FIG. 4, process 400 may include performing a set of calls on the set of processes to generate, for the enhanced data elements, a set of outputs responsive to the initial data element (block 440). For example, the data analysis system 220 (e.g., using processor 320 and/or memory 330) may perform a set of calls on the set of approval processes to generate, for the enhanced data element or request, a set of outputs responsive to the request for the approval associated with the data element or the initial request, as described above in connection with reference number 158 of FIG. 1B. As an example, the data analysis system 220 may use an API to call an approval process, an offer process, a rating process, or another process for evaluating a credit card application.

As further shown in FIG. 4, process 400 may include receiving, as a response to the set of calls, information identifying the set of outputs responsive to the initial data element (block 450). For example, the data analysis system 220 (e.g., using processor 320, memory 330, input component 340, and/or communication component 360) may receive, as a response to the set of calls, information identifying the set of outputs responsive to the request for the approval associated with the data element, as described above in connection with reference number 158 of FIG. 1B. As an example, the data analysis system 220 may receive information identifying an approval of a credit card application, an offer for the credit card application, or a rating of the credit card application.

As further shown in FIG. 4, process 400 may include transmitting the information identifying the set of outputs to fulfill the initial data element (block 460). For example, the data analysis system 220 (e.g., using processor 320, memory 330, and/or communication component 360) may transmit the information identifying the set of outputs to fulfill the request for the approval associated with the data element, as described above in connection with reference number 160 of FIG. 1C. As an example, the data analysis system 220 may output information identifying an approval of a credit card application, an offer for the credit card application, or a rating of the credit card application.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The following provides an overview of some Aspects of the present disclosure:

Aspect 1: A system for request analysis and approval, the system comprising: one or more memories; and one or more processors, communicatively coupled to the one or more memories, configured to: receive, via an interface, an initial request, wherein the initial request includes a first set of parameters; generate, using the initial request and based on the first set of parameters, an enhanced request; wherein the enhanced request is associated with the first set of parameters and a second set of parameters; identify, for the enhanced request, a set of processes based on one or more parameters of the enhanced request; identify, for the set of processes, a set of systems with which to communicate to generate a set of outputs; perform a set of calls on the set of systems to generate, for the enhanced request and using the set of processes, the set of outputs responsive to the initial request, wherein at least one call, of the set of calls, of at least one system, of the set of systems, is reusable for another system, of the set of systems, based on configuration data of the enhanced request or a condition associated with the enhanced request; receive, as a response to the set of calls, information identifying the set of outputs responsive to the initial request; and transmit the information identifying the set of outputs to fulfill the initial request.

Aspect 2: The system of Aspect 1, wherein the one or more processors, to generate the initial request, are configured to: transmit a request message to a configuration system, wherein the request message includes at least a subset of the first set of parameters; and receive, based on the request message, a response message identifying the second set of parameters.

Aspect 3: The system of any of Aspects 1-2, wherein the set of processes includes at least one of: a binary approval process associated with indicating an approval or a rejection, a numerical approval process associated with indicating a numerical value, or an approval process associated with an assignment to a category.

Aspect 4: The system of any of Aspects 1-3, wherein the one or more processors, to receive the initial request, are configured to: receive, via a first data element message, information identifying the first set of parameters; and receive, via a second data element message, a request message.

Aspect 5: The system of any of Aspects 1-4, wherein the one or more processors, to identify the set of processes, are configured to: receive information identifying a plurality of candidate processes; and select, based on the enhanced request, one or more candidate processes for the set of processes.

Aspect 6: The system of Aspect 5, wherein each candidate process, of the plurality of candidate processes, is associated with one or more processing steps or message exchanges.

Aspect 7: The system of Aspect 6, wherein the one or more processors, to receive the information identifying the set of outputs, are configured to: receive, from a process, of the set of processes, a request for a determination relating to one or more parameters of the enhanced request; and generate the determination based on the one or more parameters.

Aspect 8: The system of Aspect 7, wherein the determination is based on at least one of: an output of a machine learning model, an output of a decision tree model, or an output of a workflow.

Aspect 9: A method for data element analysis and approval, comprising: receiving, by a system and via a data element portal, a data element for analysis, wherein the data element includes a first set of parameters associated with the data element and a request for an approval associated with the data element; generating, by the system and based on the first set of parameters, an enhanced data element, wherein the enhanced data element is associated with the first set of parameters and a second set of parameters; analyzing, by the system, the enhanced data element to identify one or more approval processes; transmitting, by the system, one or more application programming interface (API) calls on one or more modules to trigger the one or more approval processes; receiving, by the system and as a response to the one or more API calls, information identifying a set of outputs responsive to the request for the approval associated with the data element; and transmitting, by the system, the information identifying the set of outputs to fulfill the request for the approval associated with the data element.

Aspect 10: The method of Aspect 9, wherein analyzing the enhanced data element comprises: categorizing the enhanced data element into a category based on the second set of parameters; and identifying the one or more approval processes corresponding to the category.

Aspect 11: The method of any of Aspects 9-10, wherein receiving the data element comprises: receiving, via a first data element message, information identifying the first set of parameters; and receiving, via a second data element message, information identifying the request for the approval.

Aspect 12: The method of any of Aspects 9-11, wherein identifying the one or more approval processes comprises: receiving information identifying a plurality of candidate approval processes; and selecting, based on the enhanced data element, the one or more approval processes from the plurality of candidate approval processes.

Aspect 13: The method of Aspect 12, wherein each candidate approval process, of the plurality of candidate approval processes, is associated with one or more processing steps or message exchanges.

Aspect 14: The method of Aspect 13, wherein receiving the information identifying the set of outputs comprises: receiving, from an approval process, of the set of approval processes, a request for a determination relating to one or more parameters of the enhanced data element; and generating the determination based on the one or more parameters.

Aspect 15: The method of Aspect 14, wherein the determination is based on at least one of: an output of a machine learning model, an output of a decision tree model, or an output of a workflow.

Aspect 16: A non-transitory computer-readable medium storing a set of instructions, the set of instructions comprising: one or more instructions that, when executed by one or more processors of a system, cause the system to: receive a submission for analysis, wherein the submission includes a first set of parameters associated with the data element and a request for an approval associated with the submission; generate, using the submission and based on the first set of parameters, an enhanced submission, wherein the enhanced submission is associated with the first set of parameters and a second set of parameters; identify, for the enhanced submission, a set of approval processes; perform a set of calls on the set of approval processes to generate, for the enhanced submission, a set of outputs responsive to the request for the approval associated with the submission; receive, as a response to the set of calls, information identifying the set of outputs responsive to the request for the approval associated with the submission; and transmit the information identifying the set of outputs to fulfill the request for the approval associated with the submission.

Aspect 17: The non-transitory computer-readable medium of Aspect 16, wherein the one or more instructions, that cause the system to generate the enhanced data element, cause the system to: transmit a request message to a configuration data source, wherein the request message includes at least a subset of the first set of parameters; and receive, based on the request message, a response message identifying the second set of parameters.

Aspect 18: The non-transitory computer-readable medium of any of Aspects 16-17, wherein the set of approval processes includes at least one of: a binary approval process associated with indicating an approval or a rejection, a numerical approval process associated with indicating a numerical value, or an approval process associated with an assignment to a category.

Aspect 19: The non-transitory computer-readable medium of any of Aspects 16-18, wherein the one or more instructions, that cause the system to receive the submission, cause the system to: receive, via a first data element message, information identifying the first set of parameters; and receive, via a second data element message, information identifying the request for the approval.

Aspect 20: The non-transitory computer-readable medium of any of Aspects 16-19, wherein the one or more instructions, that cause the system to identify the set of approval processes, cause the system to: receive information identifying a plurality of candidate approval processes; and select, based on the enhanced submission, one or more candidate approval processes for the set of approval processes.

Aspect 21: A system configured to perform one or more operations recited in one or more of Aspects 1-20.

Aspect 22: An apparatus comprising means for performing one or more operations recited in one or more of Aspects 1-20.

Aspect 23: A non-transitory computer-readable medium storing a set of instructions, the set of instructions comprising one or more instructions that, when executed by a device, cause the device to perform one or more operations recited in one or more of Aspects 1-20.

Aspect 24: A computer program product comprising instructions or code for executing one or more operations recited in one or more of Aspects 1-20.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for data element analysis and approval, the system comprising:
one or more memories; and
one or more processors, communicatively coupled to the one or more memories, configured to:
receive, via a data element portal, a data element for analysis,
wherein the data element includes a first set of parameters associated with the data element and a request for an approval associated with the data element;
generate, using the data element and based on the first set of parameters, an enhanced data element,
wherein the enhanced data element is associated with the first set of parameters and a second set of parameters;
identify, for the enhanced data element, a set of approval processes;
perform a set of calls on the set of approval processes to generate, for the enhanced data element, a set of outputs responsive to the request for the approval associated with the data element;
receive, as a response to the set of calls, information identifying the set of outputs responsive to the request for the approval associated with the data element; and
transmit the information identifying the set of outputs to fulfill the request for the approval associated with the data element.

2. The system of claim 1, wherein the one or more processors, to generate the enhanced data element, are configured to:
transmit a request message to a configuration system,
wherein the request message includes at least a subset of the first set of parameters; and
receive, based on the request message, a response message identifying the second set of parameters.

3. The system of claim 1, wherein the set of approval processes includes at least one of:
a binary approval process associated with indicating an approval or a rejection,
a numerical approval process associated with indicating a numerical value, or
an approval process associated with an assignment to a category.

4. The system of claim 1, wherein the one or more processors, to receive the data element, are configured to:
receive, via a first data element message, information identifying the first set of parameters; and
receive, via a second data element message, information identifying the request for the approval.

5. The system of claim 1, wherein the one or more processors, to identify the set of approval processes, are configured to:
receive information identifying a plurality of candidate approval processes; and
select, based on the enhanced data element, one or more candidate approval processes for the set of approval processes.

6. The system of claim 5, wherein each candidate approval process, of the plurality of candidate approval processes, is associated with one or more processing steps or message exchanges.

7. The system of claim 6, wherein the one or more processors, to receive the information identifying the set of outputs, are configured to:
receive, from an approval process, of the set of approval processes, a request for a determination relating to one or more parameters of the enhanced data element; and
generate the determination based on the one or more parameters.

8. The system of claim 7, wherein the determination is based on at least one of:
an output of a machine learning model,
an output of a decision tree model, or
an output of a workflow.

9. A method for data element analysis and approval, comprising:
receiving, by a system and via a data element portal, a data element for analysis,
wherein the data element includes a first set of parameters associated with the data element and a request for an approval associated with the data element;
generating, by the system and based on the first set of parameters, an enhanced data element,
wherein the enhanced data element is associated with the first set of parameters and a second set of parameters;
analyzing, by the system, the enhanced data element to identify one or more approval processes;
transmitting, by the system, one or more application programming interface (API) calls on one or more modules to trigger the one or more approval processes;
receiving, by the system and as a response to the one or more API calls, information identifying a set of outputs responsive to the request for the approval associated with the data element; and
transmitting, by the system, the information identifying the set of outputs to fulfill the request for the approval associated with the data element.

10. The method of claim 9, wherein analyzing the enhanced data element comprises:
categorizing the enhanced data element into a category based on the second set of parameters; and
identifying the one or more approval processes corresponding to the category.

11. The method of claim 9, wherein receiving the data element comprises:
receiving, via a first data element message, information identifying the first set of parameters; and
receiving, via a second data element message, information identifying the request for the approval.

12. The method of claim 9, wherein identifying the one or more approval processes comprises:
receiving information identifying a plurality of candidate approval processes; and
selecting, based on the enhanced data element, the one or more approval processes from the plurality of candidate approval processes.

13. The method of claim 12, wherein each candidate approval process, of the plurality of candidate approval processes, is associated with one or more processing steps or message exchanges.

14. The method of claim 13, wherein receiving the information identifying the set of outputs comprises:
receiving, from an approval process, of the set of approval processes, a request for a determination relating to one or more parameters of the enhanced data element; and
generating the determination based on the one or more parameters.

15. The method of claim 14, wherein the determination is based on at least one of:
an output of a machine learning model,
an output of a decision tree model, or
an output of a workflow.

16. A non-transitory computer-readable medium storing a set of instructions, the set of instructions comprising:
one or more instructions that, when executed by one or more processors of a system, cause the system to:
receive a submission for analysis,
wherein the submission includes a first set of parameters associated with the data element and a request for an approval associated with the submission;
generate, using the submission and based on the first set of parameters, an enhanced submission,
wherein the enhanced submission is associated with the first set of parameters and a second set of parameters;
identify, for the enhanced submission, a set of approval processes;
perform a set of calls on the set of approval processes to generate, for the enhanced submission, a set of outputs responsive to the request for the approval associated with the submission;
receive, as a response to the set of calls, information identifying the set of outputs responsive to the request for the approval associated with the submission; and
transmit the information identifying the set of outputs to fulfill the request for the approval associated with the submission.

17. The non-transitory computer-readable medium of claim 16, wherein the one or more instructions, that cause the system to generate the enhanced data element, cause the system to:
transmit a request message to a configuration data source,
wherein the request message includes at least a subset of the first set of parameters; and
receive, based on the request message, a response message identifying the second set of parameters.

18. The non-transitory computer-readable medium of claim 16, wherein the set of approval processes includes at least one of:
a binary approval process associated with indicating an approval or a rejection,
a numerical approval process associated with indicating a numerical value, or
an approval process associated with an assignment to a category.

19. The non-transitory computer-readable medium of claim 16, wherein the one or more instructions, that cause the system to receive the submission, cause the system to:
receive, via a first data element message, information identifying the first set of parameters; and
receive, via a second data element message, information identifying the request for the approval.

20. The non-transitory computer-readable medium of claim 16, wherein the one or more instructions, that cause the system to identify the set of approval processes, cause the system to:
receive information identifying a plurality of candidate approval processes; and
select, based on the enhanced submission, one or more candidate approval processes for the set of approval processes.
